(19) United States
(12) Patent Application Publication
(10) Pub. No.: US 2011/0294309 A1
(43) Pub. Date: Dec. 1, 2011

(54) EXPANSION CARD AND EXPANSION APPARATUS THEREOF

(75) Inventors: XIAO-ZHU CHEN, Shenzhen City (CN); LEI LIU, Shenzhen City (CN)

(73) Assignees: HON HAIR PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/830,537

(22) Filed: Jul. 6, 2010

(30) Foreign Application Priority Data
May 27, 2010 (CN) 201010184861.1

(51) Int. Cl. H01R 12/16

(52) U.S. Cl. 439/65

(57) ABSTRACT

An expansion card includes a card body and an expansion apparatus. The expansion apparatus includes a connection board and a connector mounted to the connection board to connect to the card body. A connection portion is mounted to the connection board and connected to the connector. When the connection portion is connected to the expansion slot, the connection portion receives signals from the expansion slot and output the signals to the card body.

### BACKGROUND

1. Technical Field

The present disclosure relates to expansion cards and, particularly, to an expansion card having an expansion apparatus.

2. Description of Related Art

In a server system, a card body, such as a network interface adapter (NIA) card body, is connected to a motherboard of the server by a connector of the card body inserted into a connector of the motherboard, with the NIA card parallel to the motherboard to save space in the server enclosure. However, there is no connector corresponding to the connector of the NIA card in other motherboards such as computer motherboards, therefore, the NIA card applied to the server can not be applied to the computer motherboard.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an exploded, isometric view of one embodiment of an expansion card, the expansion card includes a card body.

FIG. 2 is an enlarged view of the card body of FIG. 1, but viewed from another perspective.

FIG. 3 is an assembled view of the expansion card of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

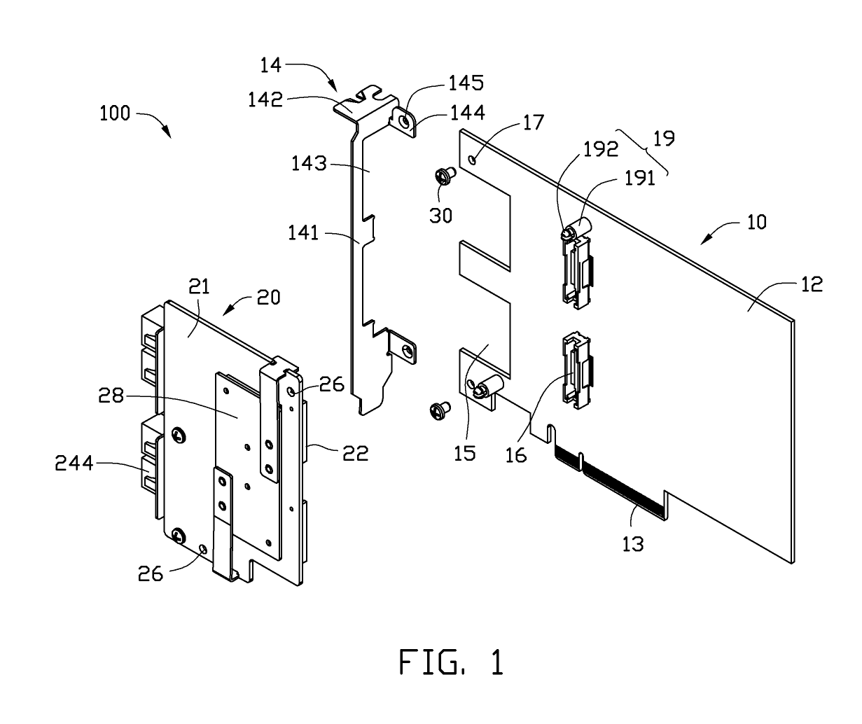

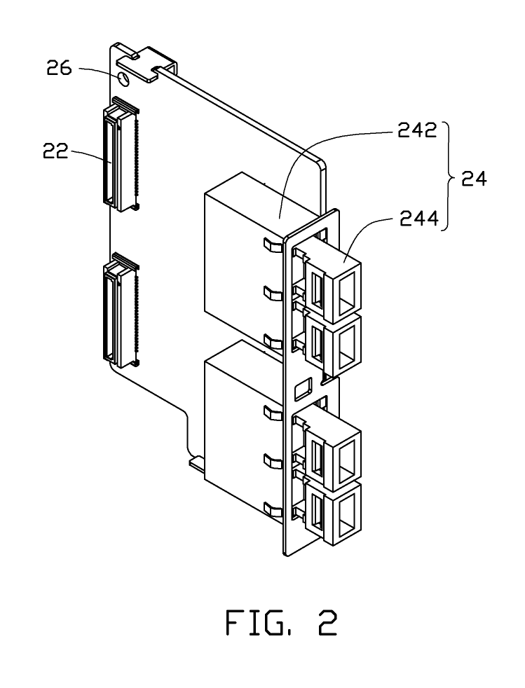

Referring to FIGS. 1 and 2, one embodiment of an expansion card, such as an expansion network interface adapter (NIA) card 100, includes a card body, such as an NIA card body 20, and an expansion apparatus 10 to connect and fix the NIA card body 20. The NIA card body 20 includes a base 21. The base 21 is substantially rectangle-shaped. The base 21 includes a first side edge, a second side edge opposite to the first side edge, a top edge, and a bottom edge opposite to the top edge. The NIA card body 20 further includes two connectors 22 mounted on a back surface of the base 21 along the first side edge of the base 21. Two network interfaces 24 are mounted on the back surface of the base 21 along the second side edge of the base 21, and a network control chip 28 is mounted on a front surface of the base 21. The network control chip 28 is used to convert peripheral component interconnect (PCI) or PCI-Express (PCIE) signals into network interface signals. Each network interface 24 includes a main body 242 mounted on the back surface of the base 21 and an inserting portion 244 extending from the main body 242. The network interface 24 is inserted into an external network. Two fixing holes 26 are defined in a conjunction between the top edge and the first side edge of the base, and a center portion adjacent to the bottom edge of the base 21 respectively.

The expansion apparatus 10 includes a connection board 12, a fixing element 14, and two connectors 16. The connection board 12 includes a first side edge, a second edge opposite to the first side edge, a top edge, and a bottom edge opposite to the top edge. A golden finger 13 is mounted to the bottom edge of the connection board 12. The golden finger 13 is electricity connected to the two connectors 16. Two cutouts 15, corresponding to the two network interfaces 24, are defined in the second side edge of the connection board 12. A screw hole 17 is defined in a conjunction between the top edge and the second side edge of the connection board 12. Two poles 19, corresponding to the two fixing holes 26 of the NIA card body 20, are mounted to the front surface of the connection board 12, to fix the NIA card body 20. Each pole 19 includes a supporting portion 191 extending from the connection board 12 to support the NIA card body 20, and a latching portion 192 extending from a distal end of the supporting portion 191. Each latching portion 192 includes two opposite claws to latching the NIA card body 20. There is a distance between the two claws. The connector 16 is mounted to the front surface of the connection board 12, corresponding to the connectors 22 of the NIA card body 20.

The fixing element 14 includes a lengthwise body 141 and a fixing portion 142 extending substantially perpendicularly from a top of the body 141. Two openings 143, corresponding to the two cutouts 15, are defined in the body 141. Two connection sheets 144 extend perpendicularly from an upper portion and a lower portion of the body 141, opposite to the fixing portion 142. A through hole 145, corresponding to the screw hole 17 of the connection board 12, is defined in each connection sheet 144.

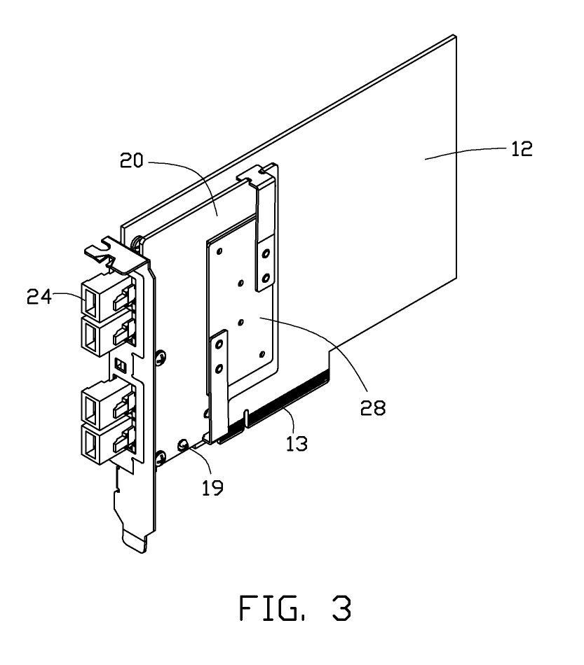

Referring to FIG. 3, in assembly, the fixing element 14 is fixed to the second side edge of the connection board 12 by two screws 30 extending through the through holes 145 of the two connection sheets 144 to engage in the screw holes 17 of the connection board 17. The two openings 143 of the fixing element 14 align with the two cutouts 15 of the connection board 12. The two network interfaces 24 of the NIA card 20 pass through the two openings 143 of the fixing element 14, with the two connectors 22 of the NIA card body 20 engaging with the connectors 16 of the connection board 12. The two latching portions 192 engage in the two fixing holes 26 of the NIA card body 20. Therefore, the NIA card 20 is fixed to the connection board 12.

In use, the golden finger 13 of the connection board 12 is inserted into a PCI or PCIE slot to receive PCI or PCIE signals from the PCI or PCIE slot. The NIA card body 20 is fixed to an electronic device enclosure (not shown) by the fixing element 14. The network control chip 28 converts the PCI or PCIE signals into the network signals to output to the network interface 24.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. An expansion card comprising:
a card body comprising a first connector; and
an expansion apparatus comprising:
a connection board;
a second connector mounted to the connection board to engage with the first connector of the card body; and
an electrical connection portion formed on the connection board and connected to the second connector.

2. The expansion card of claim 1, wherein at least one pole is mounted to the connection board, and at least one hole is defined in the card body to engage with the at least one pole, to fix the card body to the connection board.

3. The expansion card of claim 2, wherein each pole comprises a supporting portion extending from the connection board to support the card body and a latching portion extending from a distal end of the supporting portion, the latching portion comprising two opposite claws to latch the card body.

4. The expansion card of claim 1, wherein the expansion apparatus further comprises a fixing element mounted to a side of the connection board, an opening is defined in the fixing element to allow an interface of the card body to extend through the opening, and a cutout is defined in one side of the fixing element aligning with the opening.

5. The expansion card of claim 1, wherein the card body is a network interface adapter card body.

6. The expansion card of claim 1, wherein the connection portion of the connection board is a golden finger.

7. An expansion apparatus to connect a card body, the expansion apparatus comprising:
a connection board;
a connector mounted to the connection board to connect to the card body; and
an electrical connection portion mounted to the connection board and connected to the connector.

8. The expansion apparatus of claim 7, wherein at least one pole is mounted to the connection board, to fix the card body.

9. The expansion apparatus of claim 8, wherein each pole comprises a supporting portion extending from the connection board to support the card body and a latching portion extending from a distal end of the supporting portion, the latching portion comprising two opposite claws to latch the card body.

10. The expansion apparatus of claim 7, further comprising a fixing element mounted to one side of the connection board, an opening is defined in the fixing element to allow an interface of the card body to extend through the opening, and a cutout is defined in one side of the fixing element aligning with the opening.

11. The expansion apparatus of claim 7, wherein the connection portion of the connection board is a golden finger.
